(19) United States
(12) Patent Application Publication
(10) Pub. No.: US 2007/0194511 A1
(43) Pub. Date: Aug. 23, 2007

(54) WATER-TIGHT SEAL AND ATTACHMENT APPARATUS

(76) Inventor: Dana Neer, Apollo Beach, FL (US)

Correspondence Address: LARSON AND LARSON, 11199 69TH STREET NORTH, LARGO, FL, 33773, US

(21) Appl. No.: 11/691,931

(22) Filed: Mar. 27, 2007

Related U.S. Application Data
(63) Continuation-in-part of application No. 11/706,451, filed on Feb. 15, 2007.
(60) Provisional application No. 60/775,764, filed on Feb. 23, 2006.
(60) Provisional application No. 60/775,405, filed on Feb. 17, 2006.

(51) Int. Cl. B25B 11/00

(52) U.S. Cl. 269/21

(57) ABSTRACT

An application for a device for removably holding a structure to a work surface includes a base frame member, a first side of which interfaces with the structure and the second side of which has a water-tight base seal attached. At least one vacuum cell is formed in the water-tight base seal and each vacuum cell has at least one inlet port connected to a vacuum conduit for evacuating the at least one vacuum cell.

### CROSS-REFERENCE TO RELATED APPLICATION

This application is a Continuation-in-Part of U.S. patent application Ser. No. 11/706,451, filed Feb. 15, 2007, which in turn claims priority from U.S. provisional application Nos. 60/775,764 filed Feb. 15, 2006 and No. 60/775,405 filed Feb. 17, 2006, the contents of which are incorporated herein by reference.

### FIELD OF THE INVENTION

The present invention relates to a modular enclosure for providing a water-tight, controlled environment to work surfaces.

### BACKGROUND OF THE INVENTION

For years, the weather has presented problems while working on outdoor surfaces. One example of this is when resurfacing or repairing ship decks. The weather causes problems that include, but are not limited to, oxidation, improper curing of the coating, and damage to a recently worked area.

The prior art shows the use of enclosures to prevent the above weather-related problems. Some of the enclosures include tents attached to the surface of the work surface. Unfortunately, the known tents do not provide a weather-tight, controlled environment to the work surface and in many occasions, the work surface was damaged by the humidity without the application of sealants. The application of sealants creates unnecessary removal of said sealants which must be removed by manual or mechanical means from the perimeter seal area.

In view of the disadvantages shown by the tents of the prior art, it was necessary to find a way of sealing the tent to the structure or work surface. The prior art shows in some embodiments the use of the tent in combination with a perimeter frame that require semi-fluid rubber or expandable foams or similar sealants to complete a water intrusion preventive means. Unfortunately, the use of semi-fluid rubber or other sealants requires the application of the fluid or other sealants to the perimeter base frame or structure surface under or adjacent to the base frame which is not semi flexible or to the work surface of the work area and also the removal of the semi-fluid rubber after the work is completed. The use of semi-fluid rubber or other foam or similar seals is messy, labor demanding (set up and removal of the semi-fluid rubber from the work surface), expensive, and cannot be reused. Furthermore, the fluid rubber contains ingredients that may damage the surface of the work area and must be mechanically removed from the surface. The removal of such may delay work progress.

There is a necessity of providing a weather-tight, controlled environment to work surfaces that is simple to handle, non-messy, economical, reusable, and easy to set up and remove from the work area.

### SUMMARY OF THE INVENTION

In one embodiment, a device for removably holding a structure to a work surface is disclosed including a base frame member, a first side of which interfaces with the structure and the second side of which has a water-tight base seal attached. At least one vacuum cell is formed in the water-tight base seal and each vacuum cell has at least one inlet port connected to a vacuum conduit for evacuating the at least one vacuum cell.

In another embodiment, a method of removably holding a structure to a work surface is disclosed including providing a device for holding the structure to the work surface with a base frame member, a first side of which interfaces with the structure and a water-tight base seal is attached to the second side. At least one vacuum cell is formed in the water-tight base seal and has at least one inlet port interfaced to each vacuum cell with a vacuum conduit interfaced to the inlet ports for evacuating the at least one vacuum cell. The structure is secured to the device for holding the structure to the work surface. The device for holding the structure onto the work surface is placed on the work surface and the at least one vacuum cell is evacuated through the at least one inlet port, thereby holding the structure to the work surface and providing a water-tight seal.

In another embodiment, a device for holding a structure to a work surface is disclosed including an apparatus for vacuum securing the structure to the work surface, the apparatus having an upper side and a lower side, the upper side interfaces with the structure. A water-tight vacuum seal is attached to the lower side of the apparatus forming at least one vacuum cell. A source of a vacuum is connected to each vacuum cell.

An object of the present invention is to provide a water-tight, controlled environment to work surfaces.

Another object of the present invention is to provide a water-tight, controlled environment to work surfaces that is simple to handle, economical, and reusable.

Another object of the present invention is to provide a water-tight, controlled environment to work surfaces that is easy to set up and remove from the work area.

Another object of the present invention is to provide a water-tight, controlled environment to work surfaces that includes a seal that is chemically resistant.

Another object of the present invention is to provide a water-tight, controlled environment to work surfaces that leaves no residue from sealants.

The present invention relates to a modular mobile or custom static enclosure for providing a water-tight, controlled environment for a work area. An enclosure using the disclosed water-tight mechanism of the present invention can be used on any hard surface, including surfaces such as decks, concrete, skip hulls, rough surfaces, and the like.

In the present invention the work area will be described using, as an example, a ship deck. It is very important to point out that the present invention is not limited to the use of a ship deck as a work area. The present invention may be used with any work area that requires a water-tight, controlled environment.

The present invention provides a continuous water-tight seal around the surface on which it is used. The interior of the work area can be climate-controlled with the use of dehumidification, air conditioning, any other desired means, or a combination thereof.

The base rail of the present invention is semi-flexible and can conform to moderate variations of the surface on which it is installed. It also conforms to larger variations by custom cutting or forming sections of the seal with rigid or semi rigid components to aid in conforming to said larger variations or obstructions. Configurations of base frame bottom seals with vacuum cells provide a water tight seal on a work or structure surface where larger variation or obstruction or any non-moderate variations exist. The base frame with vacuum cells and vacuum seal is installed without permanently affixing it to the work surface. The custom seal section is inserted under the vacuum pliable seal to provide for a water-tight seal. In some embodiments, the enclosure resting upon the base frame has a modular interior base frame bracing and/or tension cable for strengthening the vertical enclosure upright frames and/or the roof trusses. In some embodiments, the enclosure is installed in modular sections and is affixed to the base frame to prevent racking of the enclosure while being moved or relocated. In addition, in some embodiments, the upright frames and roof trusses are designed to support the enclosure without any interior bracing or cable.

In another embodiment of the present invention interior modular strengthening frames are provided. Thus, when work is required within the enclosure, the frame is up-pined, up-bolted, released by means of binders or any applicable means know to those skilled in the art, or by means of cables, ropes or similar means. In some embodiments, the enclosure is lifted into the overhead and secured to prevent interfering with the work area surface. In embodiments where the enclosure is required to be relocated, the bracing is unsecured, lowered and affixed to the base frame. In these embodiments, the base bracing is removed in modular components and removed from the enclosure, providing an unobstructed work area.

In addition, some embodiments of the present invention relate to methods of work that are performed within the enclosure.

### BRIEF DESCRIPTION OF THE DRAWINGS

The invention can be best understood by those having ordinary skill in the art by reference to the following detailed description when considered in conjunction with the accompanying drawings in which:

FIG. 1 shows a pre-manufactured tent.

FIG. 2 shows a plan view of the perimeter base frame seal and the movable interior rack preventing base bracing along with wheel positions.

FIG. 3 shows one embodiment of the base frame seal and wheel assembly.

FIG. 4 shows an elevation view of a vertical tent truss and one embodiment of displacing the interior base rack preventing base bracing.

FIG. 5 shows the underside of the perimeter base frame and vacuum seal chambers.

FIG. 6 shows a close-up view of FIG. 5.

FIG. 7 shows the vacuum conduit for the vacuum seal.

FIG. 8 shows a close-up, detailed view of the primary embodiment of the vacuum conduit and valve system.

FIG. 9 shows the wheel assembly.

FIG. 10 shows the tent vertical truss and the connection means to the truss.

FIG. 11 shows another embodiment of a wheel assembly and connecting means to the base frame and vertical truss.

FIG. 12 shows a tension cable securing means during high winds.

FIG. 13 shows a pad eye cover.

FIG. 14 shows a cross-section of the pad eye and the pad eye cover.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The term water-tight seal refers to the ability of the seal to reduce or prevent penetration by standing water, water vapor, high water, driven water and the like. This term is not absolute, in that, under certain circumstances, water is capable of penetrating the seal. Such circumstances are related to the pressure exerted by the water and to the surface on which the water-tight seal is installed.

The disclosures in this application can be designed, implemented, combined or installed in all or in part to this inventor's patent applications, including the application entitled “Comprehensive Surface Treatment Methods and Emissions Control” filed Mar. 8, 2006; the content of which is incorporated herein by reference.

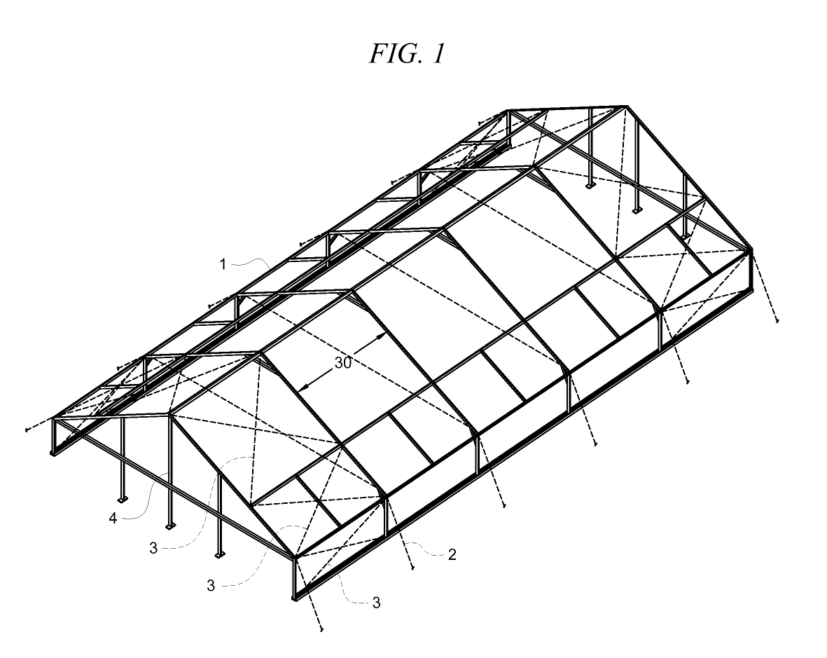

FIG. 1 shows a typical structure 1/4 such as a pre-manufactured tent frame 1/4 covered with a sheet material forming an enclosure having a weather-tight, climate-controlled atmosphere. Prior to the present invention, a method of securing the structure 1/4 to a flat or semi-flat surface such as a ship deck used tie-down cables 3.

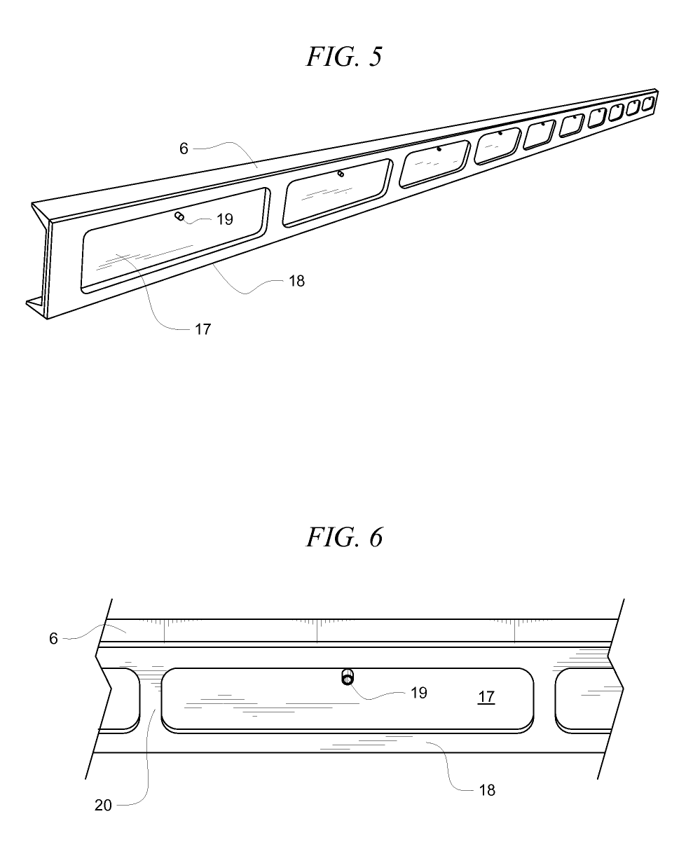

The enclosure and the vacuum seal base frame 6 (see FIG. 5), according to the present invention, may be produced of any material, size, or shape. A sheet material covering (not shown) may be of any desired material that can be installed or applied in an applicable manner known to those skilled in the art. In some embodiments, the enclosure includes interior lighting.

In some embodiments of the enclosure system, two or more enclosures are positioned as gable-end to gable-end at a distance equal to the spacing of the truss 30 and additional proper fitting sheet material is installed to cover the void. In some embodiments of the enclosure system, appendages or extensions of the enclosure are fabricated for the purpose of adjoining to a side wall of the enclosure and extending to provide additional work areas.

Environmental controlled enclosure embodiments of the present invention include a vacuum sealed base frame. The vacuum sealed base frames, at either adjoining end, are removable to provide an un-obstructed work area throughout the complete interior area.

In some embodiments, the enclosure includes wheels for moving the enclosure to the desired location.

In some embodiments, the enclosure is custom-designed and built to fit for the purpose required and the frame work is designed to strengthen the enclosure to prevent racking of the enclosure while it is being relocated to the next desired location.

In some embodiments, an interior modular frame prevents racking.

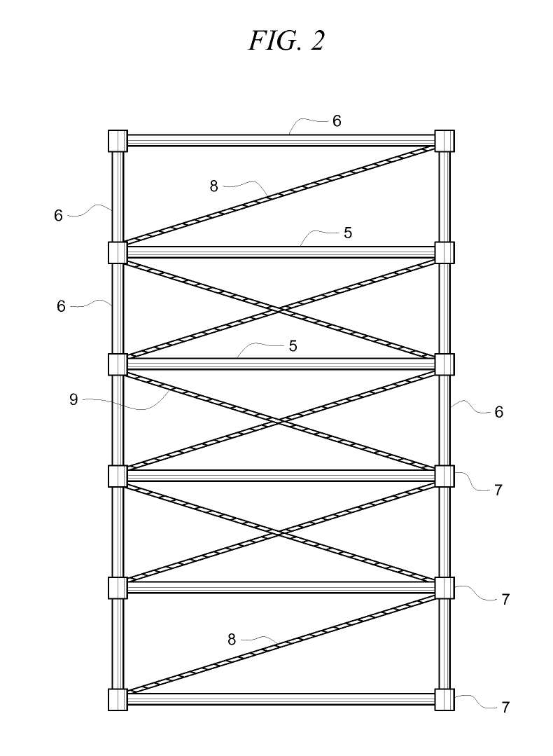

FIG. 2 shows the interior strengthening frame work 5, which is detachably affixed to the perimeter base frame 6, and has a seal as shown in FIG. 5. In some embodiments of this invention, the interior frame 5 has wheels 7 at all vertical support columns. In some embodiments, these wheel assemblies in all, or in part, either swivel or are adjustable in any desired position to direct the path in which the enclosure is to be moved. Any type of wheel assemblies known by a person skilled in the art is anticipated. In some embodiments, the wheel assemblies include a calibration disk at the top of the axle shaft.

In some embodiments, the interior frame 5 includes additional strengthening cables 8 and 9. Cables 8 are detachable from the base frame 6 in each end. Cables 9 are capable of being slackened or left tightened so the interior frame 5, cables 8 and 9 and wheel assemblies 7 will detach from the frame 6 and elevate into the overhead thereby providing an unobstructed work area.

Cables 9 include turnbuckles, ratchets, or any means known for tightening/loosening to those skilled in the art. The interior base strengthening members 5 or struts are dropped into sockets, custom designed holders, bolted, pins or detachably installed by any means known to those skilled in the art as well.

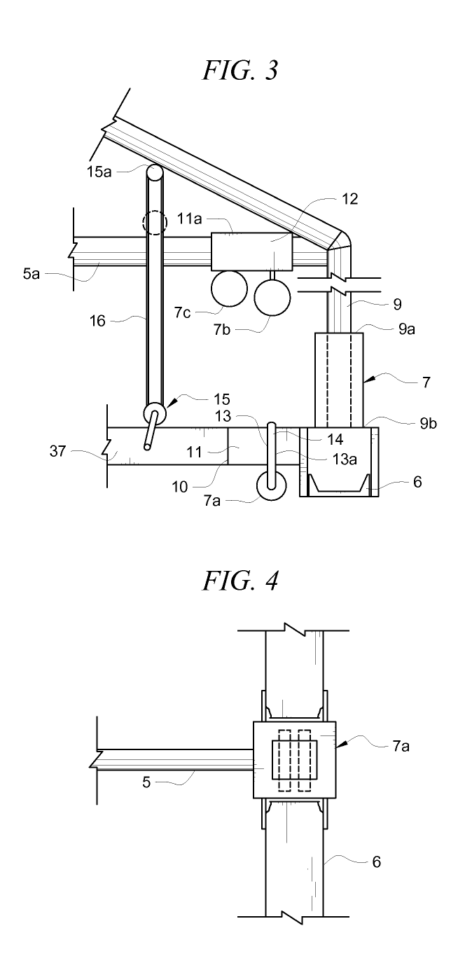

FIG. 3 shows the base framing struts or strengthening framing 5 detachably affixed to the vertical truss 9 at the perimeter seal base frame 6. In the preferred embodiment, strut 37 has a hinge 10 and the wheel assemblies 7a are installed to the swing away frame 11; so that when the interior detachable framing is elevated into the overhead as wheel assembly 12, the wheel assemblies 7a/7b are pivoted back flush with strut 37 as shown at 11a to clear vertical upright 9. The securing device 12 is a securing slot, hanger device (not shown), or any other means of securing the strut 5a. The base frame 6 and seal are discussed later. The hinged swing away frame 11 is shown moved to the upper storage position with wheel assemblies 7b or 7c. In some embodiments, the frame 11a is pivotal back against the brace or strut 37.

The modular interior frame means permits the entire interior of the enclosure to be free from any wheel assemblies and or supporting structures of said wheel assemblies.

In one embodiment the wheel assembly 7 are fabricated inline with perimeter base frame 6 as shown in FIG. 4. In such, the wheels remain in position and the seal is formed or positioned around the wheels to complete the continuous seal. The adjacent vacuum cells draw down said seals around the wheels. The wheel assemblies are detachable affixed to vertical upright stanchions at 9a or 9b. However, in the some embodiments, the wheel 7a is attached to the frame 11. In some embodiments, two or more wheel assemblies have a lock-in direction 13 by means of a pivoting shaft 13a and have an optional dial gauged directional indicator, set in the desired direction and then locked in the desired position by set screws or any means known to those skilled in the art. In some embodiments, the shaft 13a has a directional indicator 14, in which the shaft includes a means of locking into position and set and locked into the desired direction that the enclosure is to move and thereby guides the enclosure as it is pulled, pushed or motor-driven (not shown) to the next position.

As indicated before, in some embodiments, two or more wheels are locking directional wheels. Any remaining wheel assemblies swivel by means of a vertical shaft penetrating or affixed by any known means to the base perimeter base frame 6 interior brace framing or struts 37 or the interior strengthening frame work. The directional wheel assemblies are rotated by any means known to those skilled in the art. The interior struts or frame work 5 is elevated after the enclosure is in position for work to be performed. The frame 5 is elevated in the preferred embodiment by means of a cable 16 or any known means affixed to the said frame by means of a winch 15 that may be located at 15 or 15a. The frame 5 is detached by means of pins, bolts lifting out of receiving and stabilizing slots not shown.

FIG. 4 depicts a plan view of a wheel assembly 7a positioned inline with the base frame 6 with the interior frame 5 detachably affixed to said wheel assembly. The wheel assembly 7a pivots or is directionally secured in the desired direction that the enclosure is required to move. The wheel assemblies that are required to provide the desired direction to move the enclosure are installed in any two or more wheel assembly locations.

FIG. 5 shows the underside of base frame 6 and shows the water-tight seal 18 with vacuum seal cells 17. The frame 6 is made of a rigid or semi-rigid material such as aluminum, plastic, steel or iron; enabling conformation to uneven work surfaces. The water-tight seal 18 is made from a soft, pliable material that conforms to lesser deviations in the work surfaces, thereby sealing the vacuum ports 17 and providing a water-tight seal to the overall base frame 6. The water-tight seal 18 is made from a soft, pliable material such as neoprene, rubber and foam rubber.

FIG. 6 is a close-up view of one vacuum port 17. The vacuum inlet 19 is affixed to a vacuum conduit and valves (see FIG. 8). When the frame 6 is placed on the work surfaces, such as a ship deck, a vacuum pump, not shown, draws air through vacuum inlet port 19 and thereby pulling the seal firmly to the work surface and creating a water-tight seal.

Any configuration of vacuum cells is anticipated. In the preferred embodiment of the present invention, the vacuum cells are separated by dividers 20 so that each cell operates independently by its associated vacuum inlet port and valves. With such, if one or more seal cells fail or are positioned over an obstacle such as a pad eye on an aircraft carrier deck causing that vacuum cell 17 to lose vacuum, the adjacent cells will still maintain a satisfactory vacuum to secure the enclosure to the said surface. The vacuum is capable of securing the enclosure to the said surface in winds or bad weather conditions. The base frame sections 6 are, in the preferred embodiment, made of aluminum that is semi-flexible to conform to variable deviations in the work surfaces by bending of the base frame sections 6 and the strength of the vacuum pulling the base frame 6 tight to the said surface. In other embodiments, the base frame 6 is made of plastics, alloys or any material that conforms to such deviation in said surfaces.

The base frame 6 is used in any configuration and on any applicable surface, such as ship decks with rough, non-skid coating, on ship hulls, on superstructures and in combination with one or more other vacuum seal means, any number, shape, size and characteristics of vacuum cells within any size, shape or configuration or combination of frame rails. In some embodiments, the base frame 6 has wheels. The base frame 6 is formed in any dimension, orientation, length, etc., to match any applicable enclosure. The enclosure is held in any desired formation, location, or aided in same by means of any applicable configuration, combination of brackets, tie backs, tension cable, or any means know to those skilled in the art.

Multiple vacuum base frames 6 form a continuous water-tight seal along its length/width placement. Each is individually operated (locked or free) or delivered different vacuum pressures, to provide a frame and pliable seal. In some embodiments, a pliable seal (not shown) is custom-cut to install on the underside of the existing water-tight seal 18 to form a complete seal that fills large deviations in a surface. The base frame 6 conforms to deviations in a deck or similar surface without the use or any semi-liquid, liquid foam or any similar sealants.

In some embodiments, the vacuum base frames are made from durable plastics with hinged sections and are semi-flexible or formed in any shape dimensions, configuration, or length. The base frames are configurable to be affixed to a frame of any applicable enclosure. The enclosure and covering is affixed to the frame rail 6 by clamps, tension cables, or any means known to those skilled in the art.

Any number of base frames 6 are affixed to an enclosure frame, tension cables, or an enclosure that is air supported or by any means known to those skilled in the art, thereby enabling work to be performed or weather prevention to be performed within, can withstand strong winds without harm by means of the vacuum created and only requires to take up its own foot print without the need for guy cables, etc.

In some embodiments, the sheet material that makes up the enclosure can be removed from the roof trussed by means of the uprights and truss components from manufactures. The sheet material is erected and stricken by means of channels formed in the roof trusses so that the edges of the sheet material is designed to slide in and out or the channels, and the side sheets may simply be slid off the vertical uprights by means of the design.

In alternate embodiments, the base frame 6 has a vacuum seal (vacuum port 17) on one or more edges, sides, upper and lower edges, or any required configuration, to prevent water intrusion from those directions. In some embodiments, each vacuum cell is configured with a valve as known to those skilled in the art.

The present invention utilizes internal framing, bracing, cabling, or any means that stabilizes the enclosure and the vacuum base frame rail. The water-tight seal 18 is made from any pliable material. If the water-tight seal 18 fails, replacement is performed by means of inserting the frame rail with the water-tight seal 18 affixed through a jig with a hot wire to cut off the failed water-tight seal 18 and a new water-tight seal 18 is affixed. Alternately, the water tight seal 18 is cut off by a custom made knife that, in some embodiments, is heated.

The water-tight seal 18 is affixed to the base frame 6 by means of fasteners, glues or any mean known to those skilled in the art.

In some embodiment the base frames 6 are made in 20 foot lengths, but there is no restriction on the length or width of the base frames 6. In some embodiments, the base frames 6 are attachable or affixed between each vertical upright stanchion and truss 9.

The water-tight seal 18 is made of any suitable material such as rubber, foam rubber, neoprene, nylon, etc. The water-tight seal 18 is made of any desired thickness and of a material having the to conform to the surface to which it is applied.

The water-tight seal 18 is replaceable by means of cutting it from the base frame 6 with a hot blade, fitted into slots, or by any means known to those skilled in the art.

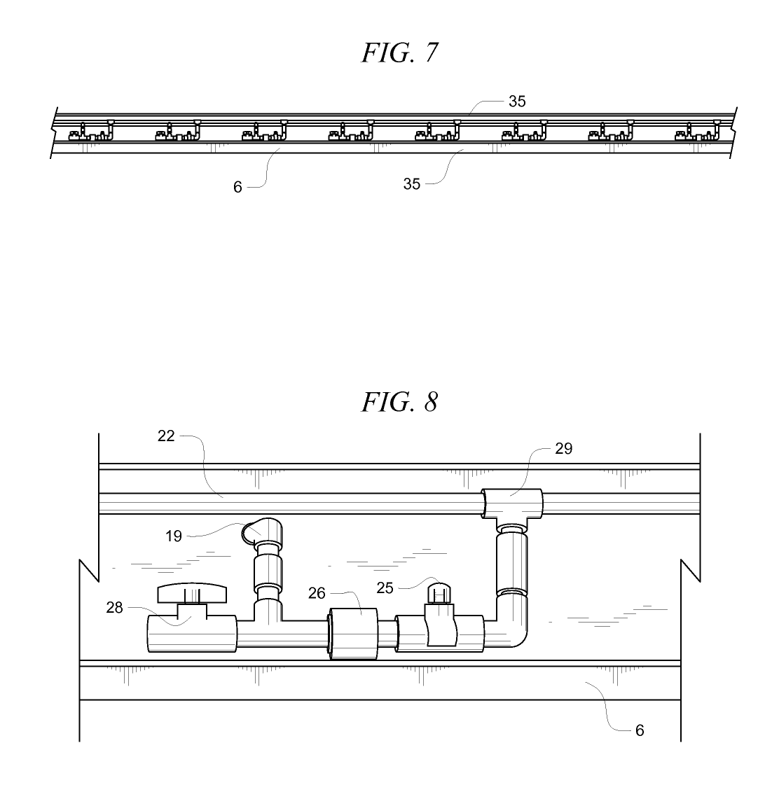

FIG. 7 shows a top view of one base frame section 6. In this embodiment, the base frame 6 is a channel iron that provides room and protection of the vacuum conduit 22 (see FIG. 8) and valve assemblies during operation of the enclosure and shipping. During shipment, the base frames 6 are stacked seal-to-seal and top edge of the channel in an alternating position and bolted to brackets (not shown) in groups for shipping.

The base frame 6 is made of any rigid or semi-flexible material and in any applicable form. The present invention uses, in the preferred embodiment, a channel of any alloy or applicable material. The flanges or upright sides 35 of the channel permit protection of the valve assemblies.

In one embodiment of the present invention, the vacuum conduits of each base frame 6 are connected one to another in series so the vacuum can be drawn from one or more locations and that each base frame 18 can communicate with one another by means of quick disconnects, detachably affixed conduit connectors or any means known to those skilled in the art.

FIG. 8 is a close-up view of the vacuum conduit and valve system. Each base rail 6 has a main vacuum conduit line 22 which runs substantially the length of the base rail 6 and is connected to other base rails 6 by means of hoses or conduit (not shown) and to one or more vacuum pumps (not shown). The vacuum pumps are of any type known in the art, such as bubble stage rapid draw vacuum pump or pumps that create a rapid initial seal or a high pressure vacuum pump or pumps to pull the maximum vacuum compressing the seal to the work surface and will draw the seal into irregularities in the work surface. Some work surfaces have rough non-skid textures such as a ship flight deck, concrete and asphalt.

In the preferred embodiment, a t-adapter 29 in the main vacuum line 22 connects to a valve assembly that connects with a vacuum cell or chamber 17 through a vacuum inlet port 19 as shown in FIG. 7. Each vacuum cell 17 is independently controlled by an optional valve 25, an optional check valve 26 and an optional release valve 28. The one-way check valve 26 prevents a vacuum leak should the vacuum pump or another vacuum cell 17 fail. Air is sucked in through the valve 25, through the check valve 26 and in through the vacuum inlet port 19. In some embodiments, a release valve 28 is provided to release the vacuum and is useful in situations where the base frames 6 needs to be relocated. The check valve 26 is an additional safety precaution to prevent the loss of vacuum in the main vacuum line 22 should there be a breach in the base seal 18 at that particular vacuum cell 17. If a breach occurs in one or more particular vacuum cells 17, all other vacuum cells 17 will still function by means closing control valve 25 for the failed vacuum cell 17.

When the seal is no longer required as in when the base frame 6 is to be moved, the vacuum needs to be releases to releasing the seal from the work surface as for the purpose of relocation of the enclosure. In this case, the release valve 28 is opened releasing the vacuum from the vacuum inlet port 19. If vacuum is still needed in the main line 22, the control valve 25 is closed. Control valve 25 is opened to allow for a vacuum to be created in its associated vacuum cell and closed when a water-tight seal fails or leaks, thereby preventing water or air from being drawn into the main line 22.

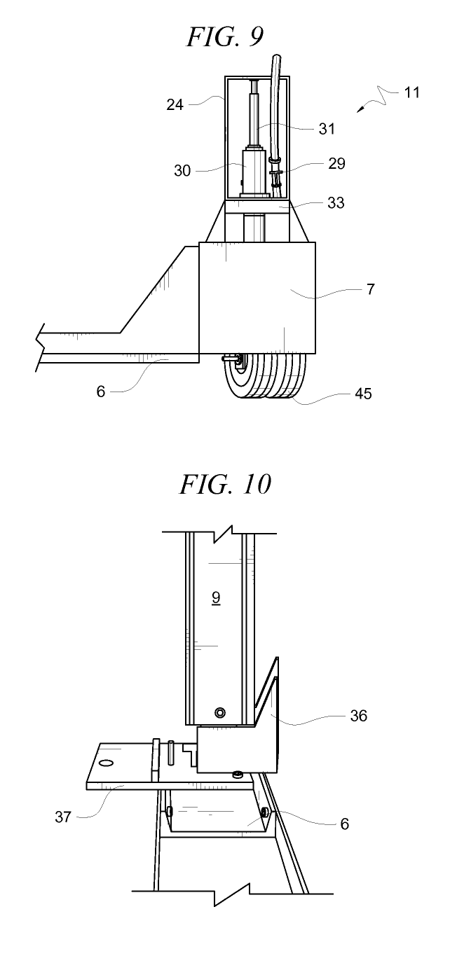

FIG. 9 shows one embodiment of an optional wheel assembly 11 that enables the enclosure to be lifted from the work surface. The wheel housing assembly 7 is connected to base rail frame 6. A hydraulic jack 30 is coupled at one end to the wheels 45 and at the other end to the jack frame 24. The hydraulic jack 30 is shown in the extended position, lifting the base rail 6 off the work surface. The ram 31 is hydraulically forced against the top of the jack frame 24, and the base of the jack forced against the movable plate 33, thereby pressing down on the wheel 45. A fluid system (not shown) controls the hydraulic jack 30 and is coupled to the hydraulic jack 30 by hydraulic tubing 29. The wheel lifting system of FIG. 9 is an example and any jack, screw or other means known to those skilled in the art for lifting the base frame 6 and hence, the enclosure, is anticipated.

FIG. 10 is an elevated view of a typical vertical upright stanchion 9, which is detachably affixed to wheel assembly 11. A securing receiver 36 is detachably affixed to base plate 37 that connects upright stanchion 9 to base rail 6. In this example, base rails 6 are adjoining in contact with each other, end to end; thereby providing a seal 17 that is continuous, preventing water intrusion around the entire perimeter of the base frame 6. Receiver 36 secures interior base framing 5 when the enclosure is in the movable mode (raised up on wheels 45).

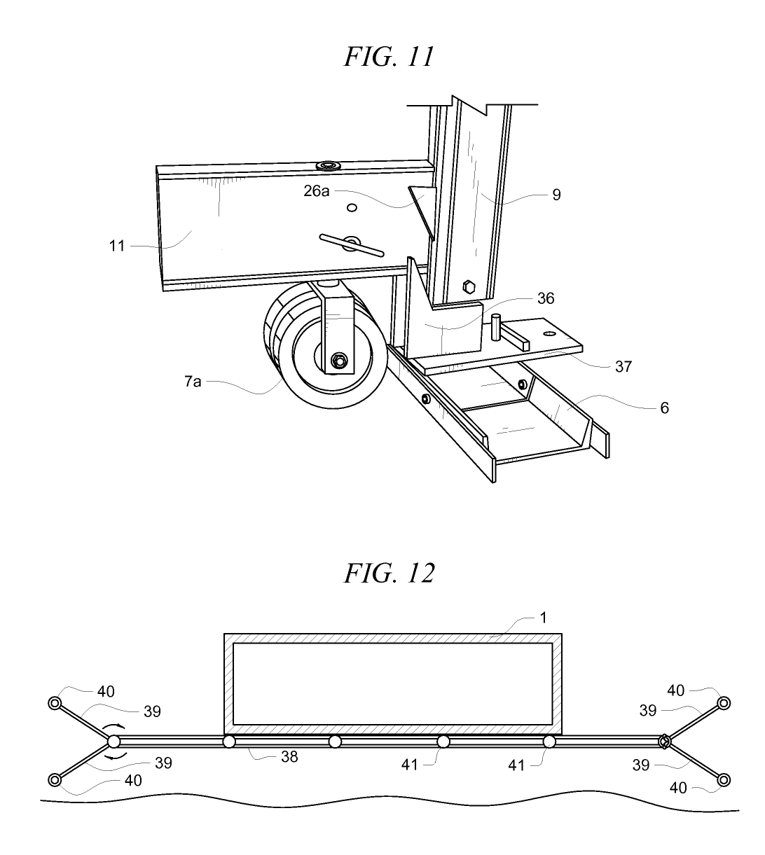

FIG. 11 shows an alternate embodiment with the pivoting wheel assembly 11 with wheel 7a which is, in turn, connected to the upright stanchion 9. A female receiver 36 on the base frame connector 37 accepts the male receiver 26a on wheel assembly.

FIG. 12 is a plan view of a means for securing or stabilizing the enclosure 1 to the deck of a ship or other work surface. Tension cable 38/39 is adjustably and detachably secured to pad eyes 40 or any placement of anchor installations by any means known to those skilled in the art. The enclosure 1 is moved along the tension cable 38/39 by means of snatch blocks 41 or any means known to those skilled in the art, for example, a ratchet system. In some embodiments (not shown), one end of the tension cable 38/39 is relocated to a distal set of pad eyes 40 to facilitate the non-linear movement of the enclosure 1. Once the tension cable 38/39 is affixed to the distal set of pad eyes 40, the tension cable 38/39 is tightened to shift the enclosure 1 to align with the new set of pad eyes 40, then the enclosure 1 is pulled along the tension cable 38/39.

In some embodiments, the interior base structural framing is retractable into the overhead. In some embodiments, any required interior frame bracing is installed at the turn of the vertical upright stanchions and the trusses.

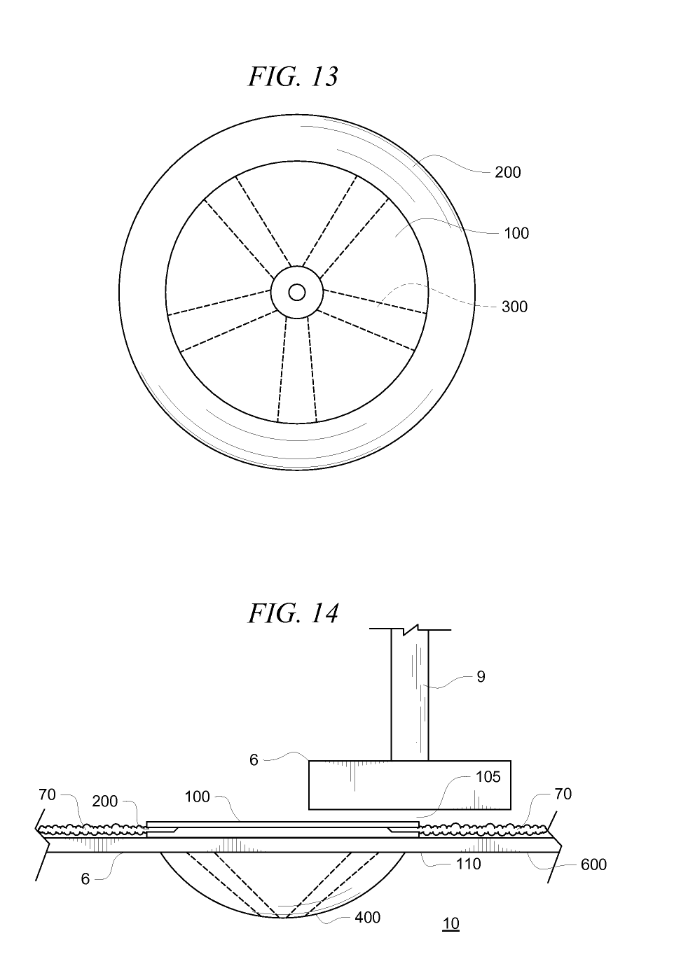

FIG. 13 shows a disk 300 for sealing over a pad eye 400 on a flight deck of a ship. An aircraft carrier deck has thousands of pad eyes 400 that are approximately 5 inches in diameter. When the perimeter base frame 6 with its water-tight seal 18 is positioned over one or more pad eyes 400, the vacuum will not function properly. To seal the pad eye 400, a thin metal disk 100 with a rubber seal 200 affixed on a bottom surface is placed over the pad eye 400 creating a water-tight seal. The vacuum press down on the disk 100 and forms a seal over the pad eye 400 preventing loss of vacuum in the vacuum cells 17 situated over the pad eye 400, thereby preventing water intrusion. In some embodiments, the disk 100 is reinforced with ribs 300.

FIG. 14 shows a cross-section showing the cupped form of the pad eye 400. The disk 200 reduces water or air leakage into the enclosure or into the vacuum securing means. When an enclosure base frame 6 is positioned over or partially over a pad eyes 400, the downward force of the enclosure 1 with stanchions 9 will assert pressure on the disk 100 forming a seal over the pad eye by means of a perimeter rubber seal 200 that forms the seal at the perimeter of the pad eye and the deck 110. The rubber seal conforms to the peaks and valleys of the deck coating 70.

In some embodiments of the present invention, the enclosure includes clean room.

In some embodiments of the present invention, additional means are deployed to secure and hold the base frame 6 to the work surface, assisting in preventing the base frame 6 from moving or sliding on the work surface. Examples of such are brackets, tension cables, and/or any other fastening means known by a person skilled in the art.

In some embodiments, the enclosure comprises doors, windows, or any other means to allow a person to get in and out of the enclosure. One or more base frames 6 may be readily removed by means of unbolting, un-pining, or by any known means to enable heavy equipment for work inside of the enclosure to be performed.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A device for removably holding a structure to a work surface, the device comprising:
a base frame member having a first side and a second side, the first side for interfacing with the structure;
a water-tight base seal attached to the second side of the base frame member;
at least one vacuum cell formed in the water-tight base seal;
at least one inlet port associated with each vacuum cell; and
a vacuum conduit operatively interfaced to the inlet ports for evacuating the at least one vacuum cell.

2. The device for holding a structure to a work surface of claim 1, wherein the vacuum conduit is operatively interfaced to a vacuum pump.

3. The device for holding a structure to a work surface of claim 2, further comprising a plurality of check valves interfaced between each inlet port and the vacuum pump for maintaining vacuum during the loss of vacuum in the vacuum conduit.

4. The device for holding a structure to a work surface of claim 3, further comprising a plurality of vacuum release valves, each interfaced between one of the inlet ports and one of the check valves for releasing vacuum thereby enabling movement of the device for holding the structure.

5. The device for holding a structure to a work surface of claim 1, further comprising retractable wheels for moving the structure on the work surface.

6. The device for holding a structure to a work surface of claim 1, wherein the water-tight base seal is made from a material selected from the group consisting of neoprene, rubber and foam rubber.

7. The device for holding a structure to a work surface of claim 1, wherein the base frame member is made from a material selected from the group consisting of aluminum, steel and plastic.

8. A method of removably holding a structure to a work surface comprising:
providing a device for holding the structure to the work surface, the device comprising:
a base frame member having a first side and a second side, the first side for interfacing with the structure;
a water-tight base seal attached to the second side of the base frame member;
at least one vacuum cell formed in the water-tight base seal;
at least one inlet port interfaced to each vacuum cell;
a vacuum conduit operatively interfaced to the inlet ports for evacuating the at least one vacuum cell;
securing the structure to the device for holding the structure to the work surface;
placing the device for holding the structure onto the work surface; and
evacuating the at least one vacuum cell through the at least one inlet port.

9. The method of holding a structure to a work surface of claim 8, wherein the vacuum conduit is operatively interfaced to a vacuum pump.

10. The method of holding a structure to a work surface of claim 9, further comprising a plurality of check valves, each interfaced between one of the inlet ports and the vacuum pump for maintaining vacuum during a loss of vacuum in the vacuum conduit.

11. The method for holding a structure to a work surface of claim 10, further comprising a plurality of vacuum release valves, each interfaced between one of the inlet ports and one of the check valves for releasing vacuum thereby enabling movement of the device for holding the structure.

12. The method for holding a structure to a work surface of claim 11, further comprising the step of opening the vacuum release valve to enable movement of the structure.

13. The method for holding a structure to a work surface of claim 8, further comprising retractable wheels for moving the structure on the work surface.

14. A device for removably holding a structure to a work surface, the device comprising:
a means for vacuum securing to the structure to the work surface, the means for vacuum securing having an upper side and a lower side, the upper side for interfacing with the structure;
a water-tight means for vacuum sealing attached to the lower side of the means for vacuum securing to the structure;
at least one vacuum cell formed in the water-tight means for vacuum securing;
a source of a vacuum;
at least one means for conducting the vacuum to each vacuum cell.

15. The device for holding a structure to a work surface of claim 14, wherein the source of the vacuum is a vacuum pump and the at least one means for conducting the vacuum is operatively interfaced to the vacuum pump.

16. The device for holding a structure to a work surface of claim 15, further comprising a means for checking the vacuum in each of the at least one vacuum cells interfaced to an inlet port of each of the at least one vacuum cells and the vacuum pump for maintaining vacuum during a loss of vacuum in the at least one means for conducting the vacuum to each vacuum cell.

17. The device for holding a structure to a work surface of claim 16, further comprising a plurality of vacuum release valves, each interfaced between one of the inlet ports and one of the means for checking the vacuum in each vacuum cell, the vacuum release valves adapted for releasing vacuum thereby enabling movement of the device for holding the structure.

18. The device for holding a structure to a work surface of claim 14, further comprising a means for relocating the structure on the work surface, the means for relocating the structure interfaced to the means for vacuum securing the structure.

19. The device for holding a structure to a work surface of claim 14, wherein the means for vacuum securing includes a base frame member and the water-tight means for vacuum sealing is a water-tight base seal affixed to the base frame member and the base frame member is made from a material selected from the group consisting of aluminum, steel and plastic.

20. The device for holding a structure to a work surface of claim 19, wherein the water-tight base seal is made from a material selected from the group consisting of neoprene, rubber and foam rubber.
